(19) United States
(12) Patent Application Publication
(10) Pub. No.: US 2007/0274281 A1
(43) Pub. Date: Nov. 29, 2007

(54) Method of Establishing a Communication Link in a Digital Communication System

(76) Inventors: Svend Henry Frandsen, Praestoe (DK); Benny Christensen, Glostrup (DK); Peter William Hilding Svendsen, Copenhagen (DK)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/580,151

(22) PCT Filed: Aug. 2, 2004
(86) PCT No.: PCT/EP04/51690

§ 371 Date: May 2, 2007

(30) Foreign Application Priority Data
Nov. 21, 2003 (GB) 0327171.5

(51) Int. Cl. H04B 7/185

(52) U.S. Cl. 370/350

(57) ABSTRACT

A method of establishing a communication between at least two communication units in a digital communication system, wherein a first communication unit operates on a long delay link and a second communication unit operates on a short delay link, wherein transmission of audio data blocks is delayed on the short delay link's site.

### FIELD OF THE INVENTION

The present invention relates to communication systems, in general, and in particular, to a method of establishing a communication between communication units in a digital communication system.

### BACKGROUND OF THE INVENTION

In digital communication systems where the voice coding is done using slow bit-rate vocoders and where a part of the communication path is via an air interface, relatively long delays may be incurred. These long delays are caused by e.g. Forward Error Correction schemes, TDM multiplexing delays, and serialisation delays for low speed links. If longer delays are added due to other factors such as re-routing over long-delay links, which may be SATCOM links or dial-up links, then the end user may suddenly experience long delays that can jeopardise the conversation quality or make the users to believe that the call is about to be dropped.

Current solutions anticipates that all links in the system operates with equal delays and operates with adding fixed delays for the call to minimise or remove loss of audio due to truncation problems. For clear communication the start of the first speech burst in a simplex call is lost, which is known in the art as the “shoot”-“don't shoot” effect, where the “don't” will be lost. The duration of the truncated speech is about equal to twice the difference in one way propagation time for long and short delay links and can be close to 600 MS.

The problem that occurs in prior art solutions is outlined in FIG. 1. For the sake of clarity communication units (e.g. portable mobile radios) are not included on the figure. A first Base Station (BS) 102, a second BS 108 and a Call Processing Server (CPS) 106 are going through an initial call set-up phase 110. Eventually the CPS 106 sends out a Channel Grant instruction 112 where the call request has been granted and the resources are allocated. The Channel Grant instruction 112 is sent to the involved Base Stations 102 and 108, which then will join 114 the multicast group that forms a multicast tree. The multicast tree allows voice data packets to flow from the sourcing Base Station to the receiving Base Station. Because of the long delay on a link on which the first BS 102 operates multicast states are not set-up in due time by a Rendezvous Point (RP) Router 104. In turn the first voice frames will be dumped 116 and this causes a problem for group calls and in particular for end-to-end encrypted calls. Group calls are typical using a direct set-up method where the voice frames floats from the source and to the destination immediately after the MS's have been sent to the traffic channels. Truncation then occurs because of the voice frames are deleted in the RP router as the multicast states hasn't been set-up in due time. The end-to-end encrypted calls will also suffer because the initial encryption synchronisation is lost and that will add another one or two seconds of audio loss. For radio communication systems with end-to-end encryption the synchronization information that synchronizes the decryption module in the receiving terminal with the encryption module in the transmitting terminal is embedded in the audio data stream. Especially in the very beginning of encrypted audio data stream repeated synchronization information replaces voice information so as to ensure that the decryption module is synchronized when encrypted voice data starts coming through. Also, every second, synchronization information is placed into the audio data stream so as to allow so called late entry. The late entry occurs in the following situation. When two secure systems are communicating, the two parties need to be in exactly the same vector state in the crypto algorithm. Most secure systems therefore send this vector as the first data. However if the receiving party misses this vector (the receiving radio could be switch off) then it would never be able to decrypt the remaining part of the message. Therefore the crypto vector is sent in small parts interleaved into the data. This enables the radio to regain the crypto synchronization even if it had lost the first part.

As in the prior art solutions the truncation removes this synchronization burst in the beginning of the data stream the terminals connected to sites will always perform late entry, which may add said one or two seconds of additional truncation.

Prior art solutions provide no special means to cope with situations where one party of the call operates on a long delay link and the other party on a short delay link. This results in said truncation. The performance with respect to call setup and voice delay is as good as it can be for the low delay links.

In duplex connection truncation is not a problem. Long voice delay due to e.g. a satellite link will, however, cause problems in conversation, as the total one way delay may be 600 ms. And this exceeds 400 ms limit, which is considered as a limit for successful duplex conversation. In networks where have a mix of short and long delay links the users in a duplex call will not know that they communicate over a long delay connection rather than a short delay connection before they actually experience conversation difficulties that require special conversation discipline. In that situation the efficiency of duplex communication is lost for the first part of the call.

### SUMMARY OF THE INVENTION

There is a need for a method for use in a digital communication system, which alleviate or overcome the disadvantages of the prior art.

According to a first aspect of the present invention there is provided a method of establishing a communication between at least two communication units in a digital communication system as claimed in claim 1.

According to a second aspect of the present invention there is provided a communication system as claimed in claim 23.

According to a third aspect of the present invention there is provided a communication unit as claimed in claim 24.

The present invention beneficially allows for consistent performance of calls with end-to-end encryption regardless of link delay. As the delay is measured during the call a delay used for adjusting the communication system is dynamically changed and this guarantees that the delay value is optimized and the quality of call and conversation is maintained on highest possible level. Further, in duplex calls with excessively long delay the users are notified about the long delay so that special conversation discipline can be applied from the beginning of the call.

### BRIEF DESCRIPTION OF THE DRAWINGS

The present invention will be understood and appreciated more fully from the following detailed description taken in conjunction with the drawings in which:

FIG. 1 is a message sequence chart illustrating a method of establishing connection in a digital communication system known in the art,

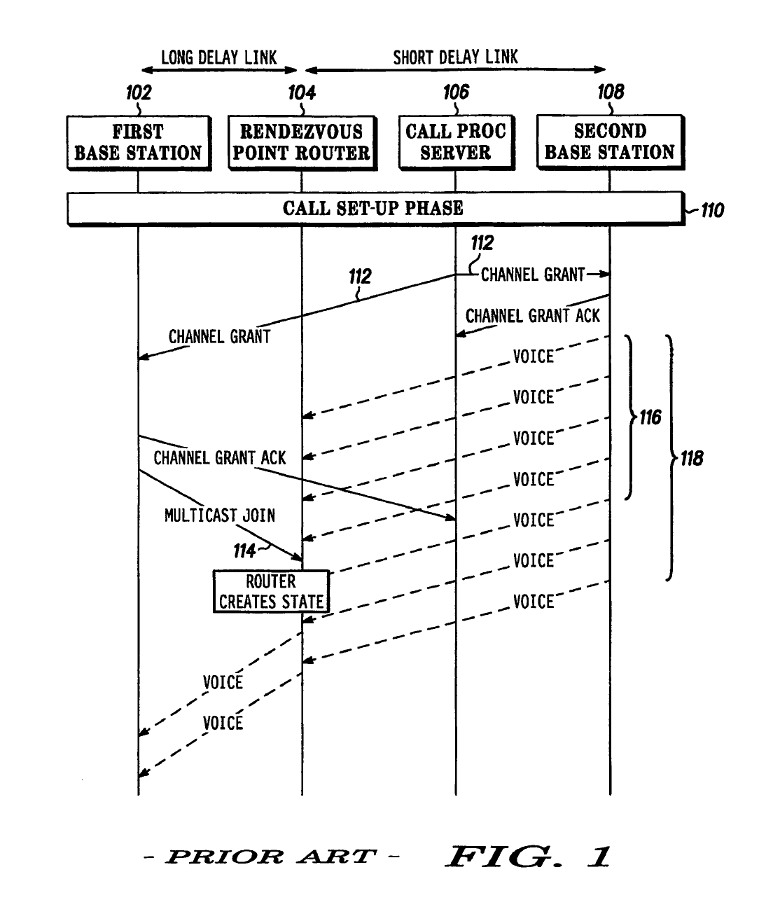

FIG. 2 is a diagram illustrating a communication system in accordance with one embodiment of the present invention,

FIG. 3 is a message sequence chart illustrating a method of establishing connection in a digital communication system in accordance with one embodiment of the present invention.

### DESCRIPTION OF AN EMBODIMENT OF THE INVENTION

The term “multicast group” herein below refers to a group of Internet Protocol end-points operating in a point to multipoint fashion.

The term “multicast tree” herein below refers to a structure comprising a number of nodes tied together with a common knowledge of each other forming a network. The structure is a tree structure where the Rendezvous Point is the root. Special IP packets known as multicast packets are floating through this tree in a point to multipoint fashion.

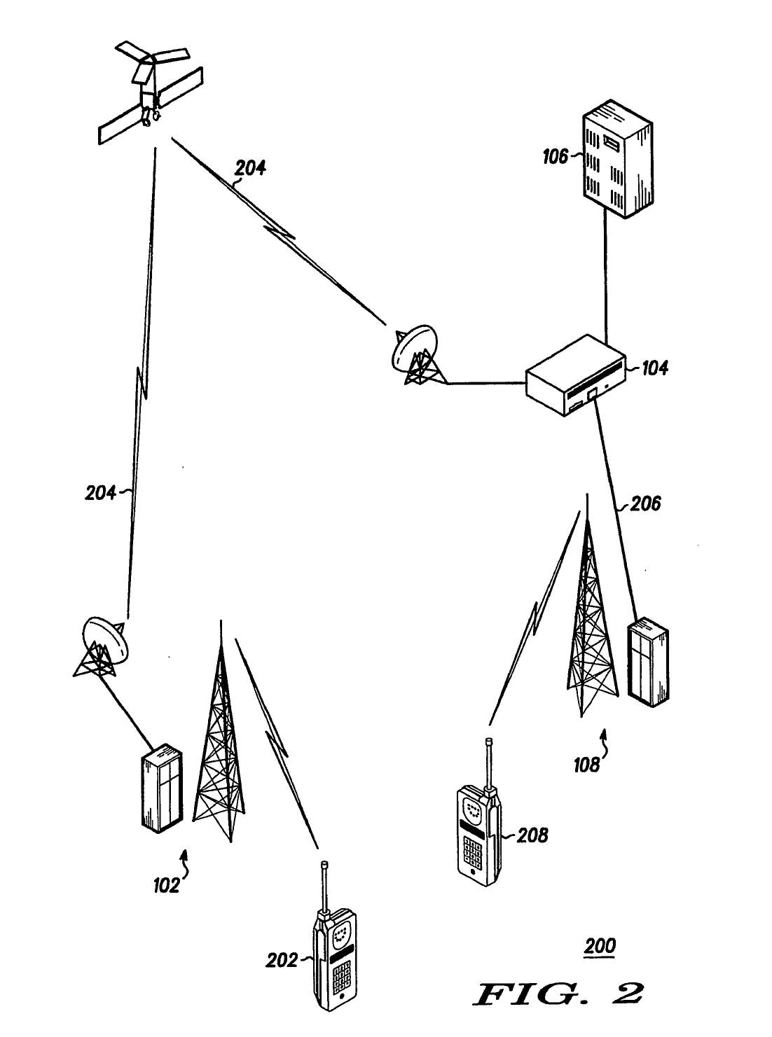

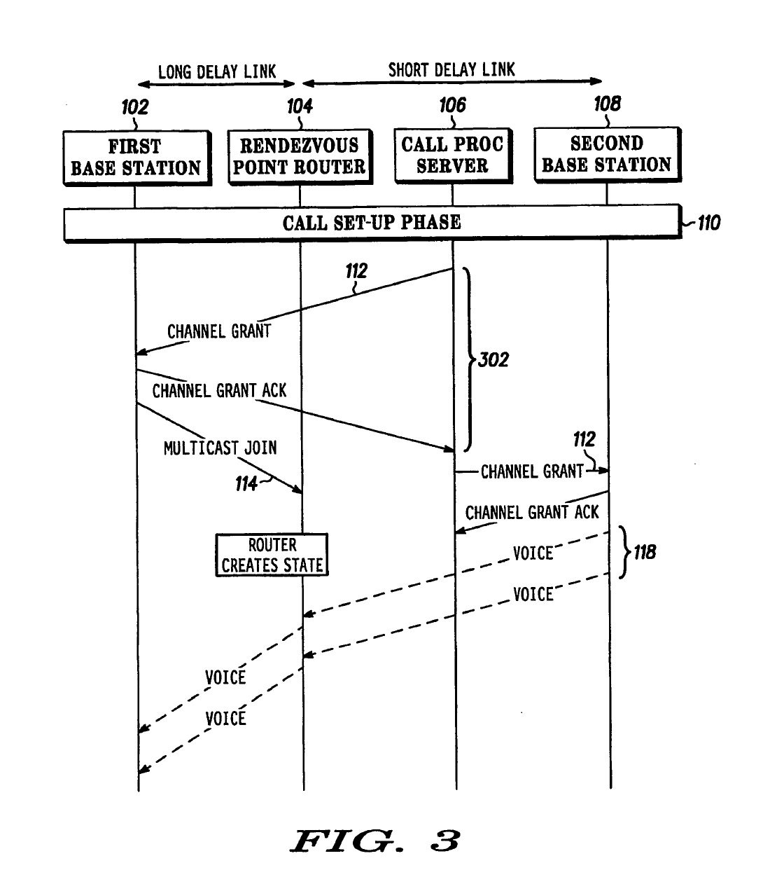

Referring to FIG. 2 and FIG. 3 one embodiment of a method of establishing communication in a digital wireless communication system 200 according to the present invention is shown. When two communication units 202 and 208 are trying to establish a communication link, wherein a first communication unit 202 operates on a long delay link 204 and a second communication unit 208 operates on a short delay link 206, then to avoid a risk of losing first audio data packets, transmission 118 of audio data blocks is delayed 302 on the short delay link's site.

In operation a first Base Station (BS) 102 and a second BS 108 and a Call Processing Server (CPS) 106 are going through an initial call set-up phase 110. Eventually the CPS 106 sends out a Channel Grant instruction 112 where the call request has been granted and a traffic channel and a Rendezvous Point (RP) router are allocated. The Channel Grant instruction 112 is sent to the involved Base Stations 102 and 108, which then join 114 the multicast group that forms a multicast tree. When the multicast tree is created the second BS starts transmitting 118 the audio data blocks to the multicast tree. The step of transmitting 118 the audio data blocks is delayed 302 by a time, which is approximately equal to twice a difference between the value of the one way propagation time on the long delay link 204 and one way propagation time on the short delay link 206. The step of transmitting 118 is delayed in a first speech item. A speech item is defined as a collection of voice frames from a Push To Talk (PTT) request to a PTT release, where both PTT request and PTT release is coming from the sourcing communication unit. Thus is defined as the voice frames that originates from one communication unit and which boundaries are when the user starts to speak by pressing PTT and stops speaking by releasing PTT.

In one embodiment the one way propagation times on the short delay link 206 and on the long delay link 204 are predefined and provided by the first BS 102 and the second BS 108. In this solution the CPS 106 maintains a table with these propagation times, which can be measured by the Base Stations and then updated in the table. The measuring of the propagation time can be performed even when the Base Stations are not involved in a call.

In another embodiment the propagation times are measured by a network infrastructure. The measurements can be done by the CPS 106 or the Base Stations 102, 108, a Base Station Controller, a Rendezvous Point (RP) router 104 or other network devices. One method that can be used for such measuring is a pinging procedure.

Once the required value of the delay 302 is known there are several possible implementations of introducing said delay.

In one embodiment said step of transmitting 118 of the audio data blocks is delayed 302 by delaying sending the Grant Channel instruction to the second BS 108.

In another embodiment said step of transmitting 118 of the audio data blocks is delayed by buffering the audio data blocks in the second BS 108.

In yet another embodiment said step of transmitting 118 of the audio data blocks is delayed by buffering the audio data blocks in the RP router 104.

In yet another embodiment said step of transmitting 118 of the audio data blocks is delayed by buffering the audio data blocks in the CPS 106.

Alternatively said step of transmitting 118 of the audio data blocks is delayed by buffering the audio data blocks in the second communication unit 208.

In modern communication systems the communication units are mobile and adapted to change their geographical location while still maintaining the call. When one of said communication units 202 or 208 changes its geographical location it can happen that it also switches to another Base Station. In such situation the propagation time of the link on which the new Base Station operates may differ from the previous one. By measuring the propagation time, during the call, the delay 302 can be dynamically adjusted to the new conditions.

In addition to applying the delay 302 users of the communication units 202 and 208 are notified by said communication units that they operates on a connection with long propagation times, which cause long delays. This notification helps the user to apply a special conversation discipline. The network infrastructure informs the communication units 202 and 208 that they operate on long propagation time connection and in turn the communication units informs their users in form of visual or audio signal.

In solutions, where the communication between the first communication unit 202 and the second communication unit 208 are secured by an end-to-end encryption said delaying 302 of the transmission of the audio data blocks ensures that synchronization data blocks are not lost. In result it is not necessary to perform “late entry”. The synchronization data blocks in end-to-end encryption replace corresponding amount of the audio data blocks at the beginning of data stream.

In one embodiment said first communication unit 202 and said second communication unit may operate in different communication systems.

It is worth to note that the solution can be applied to simplex calls as well as to duplex calls, to group calls and to calls using a direct set-up.

1. A method of establishing a communication between at least two communication units in a digital communication system comprising:
transmitting audio data blocks,
wherein a first communication unit operates on a long delay link and a second communication unit operates on a short delay link, and
wherein the transmitting of audio data blocks is delayed on a site of the short delay link.

2. The method according to claim 1 wherein the step of transmitting audio data blocks further comprises the steps:
a) initiating a call set-up phase between a first Base Station (BS) and a second BS and a Call Processing Server (CPS), wherein the first BS operates on the long delay link and the second BS operates on the short delay link;
b) sending by the CPS a Channel Grant instruction to the first BS and to the second BS;
c) joining by the first BS and the second BS a multicast group;
d) creating a multicast tree; and
e) transmitting the audio data blocks to the multicast tree.

3. The method according to claim 2, wherein a value of the delay added on the short delay link is approximately equal to twice a difference between a value of a one way propagation time on the long delay link and a one way propagation time on the short delay link.

4. The method according to claim 3, wherein the one way propagation times on the short delay link and on the long delay link are predefined and provided by the first BS and the second BS.

5. The method according to claim 3, wherein the one way propagation times on the short delay link and on the long delay link are measured by a network infrastructure.

6. The method according to claim 5, wherein the one way propagation times on the short delay link and the long delay link are measured by the CPS.

7. The method according to claim 2, wherein said step of transmitting the audio data blocks is delayed by delaying sending the Channel Grant instruction to the second BS.

8. The method according to claim 2, wherein said step of transmitting the audio data blocks is delayed by buffering the audio data blocks in at least one of a) the second BS, b) a Rendezvous Point (RP) router, c) the second communication unit, and d) the CPS.

9. (canceled)

10. (canceled)

11. (canceled)

12. The method according to claim 5, wherein a pinging procedure is used for the measuring.

13. The method according to claim 1, wherein the delay dynamically varies, while any one of the communication units switch to another link with a different one way propagation time.

14. The method according to claim 1, wherein the first communication unit and the second communication unit notify their users that they operate on a connection with a long delay.

15. The method according to claim 14 wherein an audio or visual signal is used to notify.

16. The method according to claim 1, wherein the communication between the first communication unit and the second communication unit is at least one of a simplex communication and a duplex communication.

17. (canceled)

18. The method according to claim 1, wherein the communication between the first communication unit and the second communication unit is secured by an end-to-end encryption.

19. The method according to claim 18, wherein synchronization data blocks replace a corresponding amount of the audio data blocks at a beginning of data stream.

20. The method according to claim 1, wherein the communication between the at least two communication units is a call using a direct set-up method.

21. The method according to claim 1, wherein said step of transmitting audio data blocks is delayed in a first speech item.

22. The method according to claim 1, wherein said first communication unit and said second communication unit operate in different communication systems.

23. (canceled)

24. (canceled)

25. The method according to claim 1, wherein the first communication unit is a TETRA radio or an ASTRO/APCO 25 radio or an IDEN radio, a GSM radio, a GSM-R radio or any radio in a digital radio system utilizing a low rate vocoder.
